(19) United States
(12) Patent Application Publication
(10) Pub. No.: US 2016/0070408 A1
(43) Pub. Date: Mar. 10, 2016

(54) ELECTRONIC APPARATUS AND APPLICATION EXECUTING METHOD THEREOF

(71) Applicant: Samsung Electronics Co., Ltd., Suwon-si (KR)

(72) Inventors: Jung Yun CHOI, Seoul (KR); Hye Jin KANG, Suwon-si (KR); Seung Ho SONG, Seoul (KR); Ji Min AN, Yongin-si (KR); Yong Whi LEE, Seoul (KR)

(21) Appl. No.: 14/846,054

(22) Filed: Sep. 4, 2015

(30) Foreign Application Priority Data
Sep. 5, 2014 (KR) 10-2014-0119152

(51) Int. Cl. G06F 3/041; H04N 5/232; H04N 5/77; G06F 3/0488

(52) U.S. Cl. CPC G06F 3/0416; G06F 3/0412; G06F 3/04883; H04N 5/23216; H04N 5/772; H04N 5/23293; G06F 2203/04808

(57) ABSTRACT

An electronic apparatus is provided. The electronic apparatus includes a display configured to display an object for an application execution, an input module configured to receive a touch manipulation on an object, and a control module configured to execute a first application if the touch manipulation ends in a first region and execute a second application if the touch manipulation ends in a second region. The control module is further configured to change an area of the first region and an area of the second region according to the number of executions or execution time of the first application and the second application.

### CROSS-REFERENCE TO RELATED APPLICATION(S)

This application claims the benefit under 35 U.S.C. §119(a) of a Korean patent application filed on Sep. 5, 2014 in the Korean Intellectual Property Office and assigned Serial number 10-2014-0119152, the entire disclosure of which is hereby incorporated by reference.

### TECHNICAL FIELD

The present disclosure relates to an electronic apparatus capable of executing an application and an application execution method thereof.

### BACKGROUND

With the development of electronic technology, various electronic apparatuses have been developed and distributed. Especially, a smart electronic apparatus such as a smart-phone, a tablet personal computer (PC), or the like has come into wide use.

A smart electronic apparatus such as a smart-phone, a tablet PC, or the like can provide various services such as mail, photo shooting, video reproducing, weather forecast, traffic information, or the like. Various user interfaces are being developed to provide the various services conveniently and intuitively.

Generally, an application installed on a smart electronic apparatus is executed through icon-type objects which are displayed at regular intervals on a main screen. Accordingly, to execute a specific application at an idle state, a user inputs a password at a lock screen for entering into a main screen and touches an icon-type object.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electronic apparatus and an application execution method thereof capable of conveniently executing an application on a lock screen and conveniently and intuitively executing a specific application by providing a user interface (UI) for execution of an application.

In accordance with an aspect of the present disclosure, an electronic apparatus is provided. The electronic apparatus includes a display configured to display an object for an application execution, an input module configured to receive a touch manipulation on the object, and a control module configured to execute a first application if the touch manipulation ends in a first region and execute a second application if the touch manipulation ends in a second region. The control module may be further configured to change an area of the first region and an area of the second region according to the number of executions or execution time of the first application and the second application.

In accordance with another aspect of the present disclosure, an application executing method of an electronic apparatus is provided. The application executing method includes displaying an object for execution of an application, receiving a touch manipulation on the object, executing a first application if the touch manipulation on the object ends in a first region and executing a second application if the touch manipulation ends in a second region, and changing an area of the first region and an area of the second region according to the number of executions or execution time of the first application and the second application.

In accordance with another aspect of the present disclosure, a computer-readable recording medium recorded with a program which performs a method is provided. The method includes displaying an object for execution of an application, receiving a touch manipulation on the object, executing a first application if the touch manipulation on the object ends in a first region and executing a second application if the touch manipulation ends in a second region, and changing an area of the first region and an area of the second region according to the number of executions or execution time of the first application and the second application.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is block diagram illustrating a configuration of an electronic apparatus according to various embodiments of the present disclosure;

FIGS. 2A, 2B, and 2C are diagrams illustrating an application execution operation according to various embodiments of the present disclosure;

FIGS. 3A, 3B, 4A, 4B, 5A, and 5B are diagrams illustrating an application execution region according to various embodiments of the present disclosure;

FIGS. 6A and 6B are diagrams illustrating a user interface (UI) indicating an application execution region according to various embodiments of the present disclosure; and

FIG. 7 is a flowchart illustrating an application execution method of an electronic apparatus according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents

It is to be understood that the singular forms “a,” “an,” and “the” include plural referents unless the context clearly dictates otherwise. Thus, for example, reference to “a component surface” includes reference to one or more of such surfaces.

The term “include,” “comprise,” “including,” or “comprising” used herein indicates disclosed functions, operations, or existence of elements but does not exclude other functions, operations or elements. It should be further understood that the term “include”, “comprise”, “have”, “including”, “comprising”, or “having” used herein specifies the presence of stated features, integers, operations, elements, components, or combinations thereof but does not preclude the presence or addition of one or more other features, integers, operations, elements, components, or combinations thereof.

The meaning of the term “or” or “at least one of A and/or B” used herein includes any combination of words listed together with the term. For example, the expression “A or B” or “at least one of A and/or B” may indicate A, B, or both A and B.

The terms, such as “first”, “second”, and the like used herein may refer to various elements of various embodiments of the present disclosure, but do not limit the elements. For example, such terms do not limit the order and/or priority of the elements. Furthermore, such terms may be used to distinguish one element from another element. For example, “a first user device” and “a second user device” indicate different user devices. For example, without departing the scope of the present disclosure, a first element may be referred to as a second element, and similarly, a second element may be referred to as a first element.

In the description below, when one part (or element, device, etc.) is referred to as being “connected” to another part (or element, device, etc.), it should be understood that the former can be “directly connected” to the latter, or “electrically connected” to the latter via an intervening part (or element, device, etc.). It will be further understood that when one component is referred to as being “directly connected” or “directly linked” to another component, it means that no intervening component is present.

Unless otherwise defined herein, all the terms used herein, which include technical or scientific terms, may have the same meaning that is generally understood by a person skilled in the art.

It will be further understood that terms, which are defined in a dictionary and commonly used, should also be interpreted as is customary in the relevant related art and not in an idealized or overly formal sense unless expressly so defined herein in various embodiments of the present disclosure.

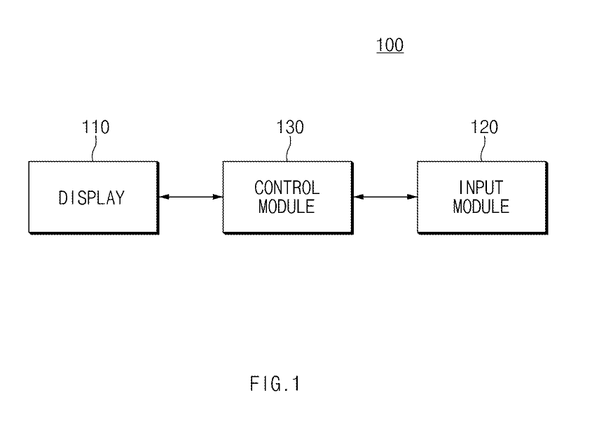

FIG. 1 is a block diagram illustrating an electronic apparatus according to various embodiments of the present disclosure.

Referring to FIG. 1, an electronic apparatus 100 may include a display 110, an input module 120 or a control module 130. According to an embodiment of the present disclosure, the electronic apparatus 100 may be implemented with an electronic apparatus including a display such as a television (TV), a smart-phone, a personal digital assistant (PDA), a notebook personal computer (PC), a desktop PC, a tablet PC, or the like.

The display 110 may display contents, various user interfaces (UIs) or an object. According to an embodiment of the present disclosure, the display 110 may display an object for execution of an application. For example, the display 110 may display an object for execution of an application on a lock screen. The term lock screen may mean a screen used to receive user manipulations such as a password input, a touch, and the like to enter a main screen.

According to an embodiment of the present disclosure, the display 110 may include a plurality of application execution areas (e.g., two or more). For example, the display 110 may include a first region, in which a first application is executed, and a second region, in which a second application is executed, according to a touch manipulation of a user.

The input module 120 may receive a user manipulation. According to an embodiment of the present disclosure, the input module 120 may receive a touch manipulation from a user. For example, the input module 120 may receive touch manipulations such as a swipe, a flick, and the like. According to an embodiment of the present disclosure, a user may input a touch manipulation to an object displayed in the display 110 to execute an application.

According to an embodiment of the present disclosure, the input module 120 may be implemented with a touch screen or a touch pad, which operates according to a touch input of a user.

The control module 130 may control an overall operation of the electronic apparatus 100. For example, the control module 130 may control each of the display 110 and the input module 120 and may execute an application according to various embodiments of the present disclosure.

According to an embodiment of the present disclosure, the control module 130 may recognize a touch manipulation of a user and may execute an application according to the recognized touch manipulation. For example, the control module 130 may execute the first application if a touch manipulation of a user ends in a first region of the display 110 and may execute the second application if a touch manipulation of a user ends in a second region of the display 110.

According to an embodiment of the present disclosure, the first application may be a front camera application and the second application may be a rear camera application.

According to an embodiment of the present disclosure, the first application and the second application may be changed by a user setting.

According to an embodiment of the present disclosure, the first region may be one of a plurality of regions that result by passing a straight line through an object and the second region may be the other of the regions divided by the straight line passing through the object. According to an embodiment of the present disclosure, the first region or the second region may be at least a portion (e.g., a part or all) of each of the plurality of regions resulting from passing a straight line through an object.

According to an embodiment of the present disclosure, the first region may be an inner region of an arc of a circle of which the center is an object or an edge adjacent to the object, and the second region may be an outer region of the arc of the circle of which the center is the object or the edge adjacent to the object. According to an embodiment of the present disclosure, the second region may be at least a portion (e.g., a part or all) of an outer region of an arc of a circle of which the center is an object.

According to an embodiment of the present disclosure, a control module 130 may change an area of the first region and an area of the second region. For example, the control module 130 may change an area of the first region and an area of the second region in proportion to the number of executions or execution time of the first application and the second application. According to an embodiment of the present disclosure, the control module 130 may increase an area, which is initially set, of the first region and an area, which is initially set, of the second region according to the number of executions or execution time of the first application and the second application. According to an embodiment of the present disclosure, the control module 130 may change a ratio of an area of the first region to an area of the second region, with the whole region of the first and second regions maintained.

According to an embodiment of the present disclosure, the number of executions or execution time of an application may be initialized by a user. According to an embodiment of the present disclosure, if the number of executions or the execution time of an application is initialized, a control module 130 may initialize an area of the first region and an area of the second region with an area (e.g., 1:1) which is initially set.

According to an embodiment of the present disclosure, the display 110 may include three or more application execution regions. For example, the display 110 may include a third region for execution of a third application, as well as the first region for execution of the first application and the second region for execution of the second application.

According to an embodiment of the present disclosure, the control module 130 may execute the first application if a touch manipulation of a user ends in the first region. The control module 130 may execute the second application if a touch manipulation of a user ends in the second region. The control module 130 may execute the third application if a touch manipulation of a user ends in the third region.

According to an embodiment of the present disclosure, the control module 130 may perform control to display a UI indicating each application execution region to distinguish a plurality of application execution regions. For example, the control module 130 may display each of the first region and the second region with different hues, brightness, or saturations. As another example, the control module 130 may perform control to display a name of an application corresponding to each of the first region and the second region with a text. As a further example, the control module 130 may perform control to display an icon of an application corresponding to each of the first region and the second region. In a still another example, if the first application and the second application are a front camera application and a rear camera application respectively, the control module 130 may perform control to display a person image in the first region and a background image in the second region, respectively. According to an embodiment of the present disclosure, an electronic apparatus 100 may include a front camera photographing an image in front of the electronic apparatus 100 and a rear camera photographing an image in the rear of the electronic apparatus 100. According to an embodiment of the present disclosure, if the first application and the second application are a front camera application and a rear camera application respectively, the control module 130 may display an image photographed by the front camera and an image photographed by the rear camera in the first region and the second region respectively.

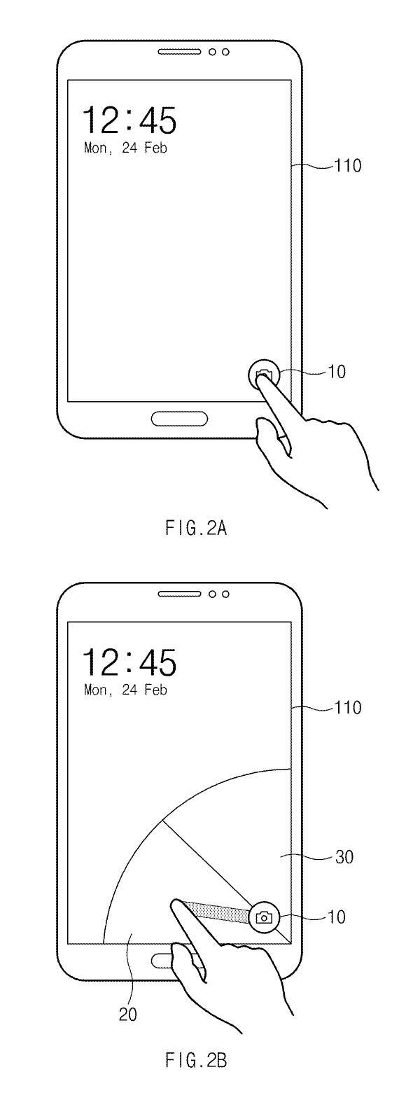

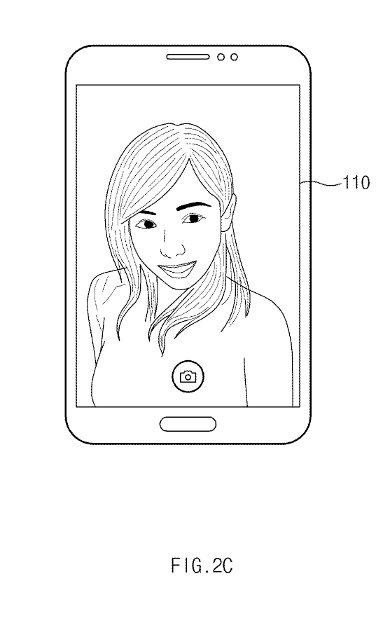

FIGS. 2A, 2B, and 2C are diagrams illustrating an application execution operation according to various embodiments of the present disclosure.

Referring to FIG. 2A, a display 110 may display an object 10 for execution of an application on a lock screen. A user may input a touch manipulation (e.g., a swipe manipulation) with respect to the object 10.

Referring to FIG. 2B, the display 110 may include a first region 20 and a second region 30. If a touch manipulation on the object 10 ends in the first region 20, a first application (e.g., a front camera application) may be executed. If a touch manipulation on the object 10 ends in the second region 30, a second application (e.g., a rear camera application) may be executed.

Referring to FIG. 2B, if a touch manipulation of a user ends in the first region 20, the first application (e.g., a front camera application) may be executed as illustrated in FIG. 2C.

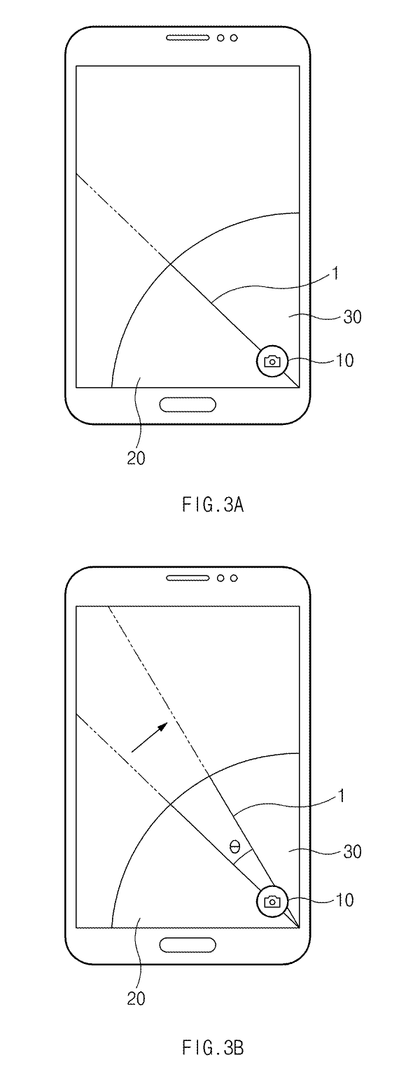

FIGS. 3A and 3B are diagrams illustrating an application execution region according to various embodiments of the present disclosure.

Referring to FIG. 3A, a first region 20 may be a portion of one of a plurality of regions that result by passing a straight line 1 passing through an object 10. A second region 30 may be a portion of the other of the regions divided by the straight line 1 passing through the object 10.

Referring to FIG. 3B, aspects of the first region 20 and the second region 30 may be changed. For example, the first region 20 and the second region 30 may be changed according to the number of executions or execution time of an application.

According to an embodiment of the present disclosure, an area of the first region 20 and an area of the second region 30 may be changed in proportion to the number of executions or execution time of a first application and a second application. For example, in the case where the number of executions of the first application is 10 and the number of executions of the second application is 5, a ratio of an area of the first region 20 to an area of the second region 30 may be changed into 2:1.

According to an embodiment of the present disclosure, a ratio of an area of the first region 20 to an area of the second region 30 may be changed, with the whole region of the first region 20 and the second region 30 maintained. For example, an area of the first region 20 and an area of the second region 30 may be changed by rotating (or changing) the straight line 1, which passes through the object 10, clockwise or counterclockwise by an angle. As understood from FIGS. 3A and 3B, an area of the first region 20 and an area of the second region 30 may be changed by rotating (or changing) the straight line 1, which passes through the object 10, clockwise by an angle of 0.

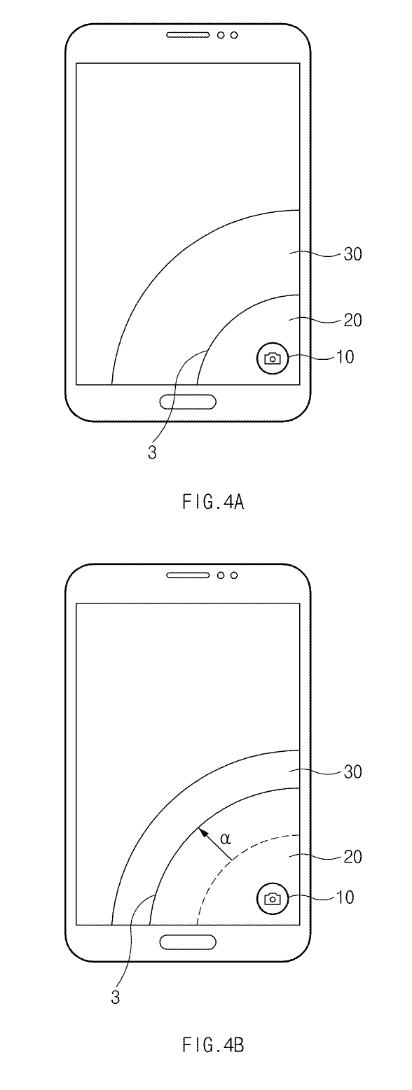

FIGS. 4A and 4B are diagrams illustrating an application execution region according to various embodiments of the present disclosure.

Referring to FIG. 4A, a first region 20 may be an inner region of an arc of a circle 3 of which the center is an edge adjacent to an object 10, and a second region 30 may be a portion of outer regions of the arc of the circle 3 of which the center is the edge adjacent to the object 10.

Referring to FIG. 4B, the first region 20 and the second region 30 may be changed. The first region 20 and the second region 30 may be changed according to the number of executions or execution time of an application. According to an embodiment of the present disclosure, an area of the first region 20 and an area of the second region 30 may be changed in proportion to the number of executions or execution time of a first application and a second application. For example, in the case where the execution time of the first application is an hour and the execution time of the second application is half an hour, a ratio of an area of the first region 20 to an area of the second region 30 may be changed into 2:1.

According to an embodiment of the present disclosure, a ratio of an area of the first region 20 to an area of the second region 30 may be changed, with the whole region of the first region 20 and the second region 30 being maintained. For example, an area of the first region 20 and an area of the second region 30 may be changed by changing a radius of the arc of the circle 3 of which the center is the object 10 or is an edge adjacent to the object 10. As understood from FIGS. 4A and 4B, an area of the first region 20 and an area of the second region 30 may be changed by changing a radius of the arc of the circle 3, of which the center is the edge adjacent to the object 10, as many as a.

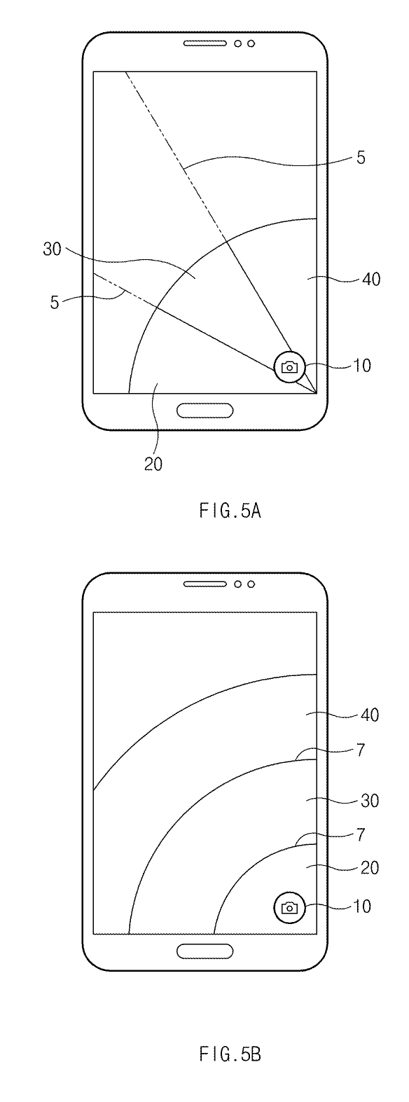

FIGS. 5A and 5B are diagrams illustrating an application execution region according to various embodiments of the present disclosure.

Referring to FIG. 5A, a first region 20 may be at least a portion of one among three regions divided by two straight lines 5 passing through an object 10. A second region 30 may be at least a portion of another among the three regions. A third region 40 may be at least a portion of the other among the three regions.

Referring to FIG. 5B, the first region 20 may be an inner region of three regions divided by two arcs of circles 7 of which the center is an edge adjacent to the object 10. The second region 30 may be a middle region of the three regions. The third region 40 may be a portion of an outer region of the three regions.

According to an embodiment of the present disclosure, a control module 130 may change an area of the first region 20, an area of the second region 30, and an area of the third region 40 according to the number of executions or execution time of a first application, a second application, and a third application, respectively.

Application execution regions described with reference to FIGS. 3A to 5B may be distinguishable from each other in a display 110 using various manners. For example, the first region and the second region may be distinguishable from each other by an ellipse of which the center is an object or is an edge adjacent to the object, or a curve surrounding the object. As another example, the first and second regions may be discontinuous with each other (e.g., two discontinuous arcs of circles), respectively.

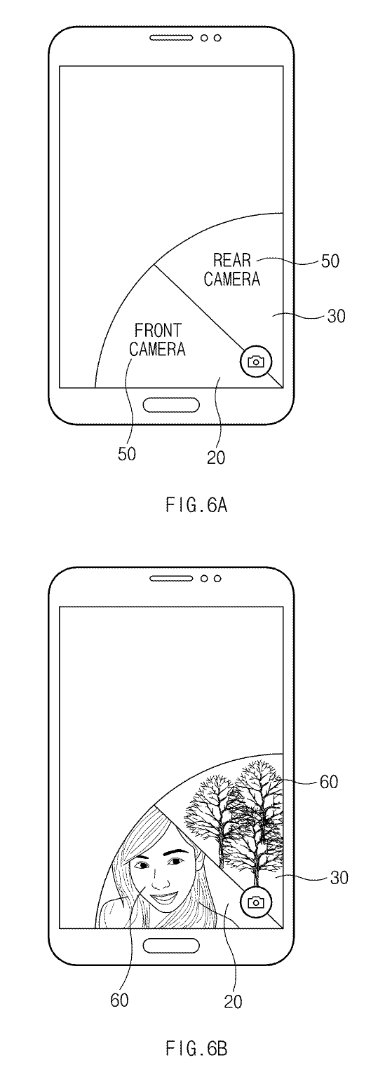

FIGS. 6A and 6B are diagrams illustrating a UI indicating an application execution region according to various embodiments of the present disclosure.

Referring to FIG. 6A, names of applications 50 corresponding to first and second regions 20 and 30 may be displayed using a text. For example, if a first application is a front camera application and a second application is a rear camera application, as illustrated in FIG. 6A, “front camera” may be displayed in the first region 20, and “rear camera” may be displayed in the second region 30.

Referring to FIG. 6B, a UI 60 indicating an application execution screen may be displayed in the first region 20 and the second region 30. For example, if the first application is a front camera application and the second application is a rear camera application, as illustrated in FIG. 6B, an image photographed by the front camera may be displayed in the first region 20, and an image photographed by the rear camera may be displayed in the second region 30.

According to an embodiment of the present disclosure, if a touch manipulation on an object 10 is inputted (e.g., the time when a touch manipulation is first recognized, or after the time), a control module 130 may display a UI indicating an application execution region.

According to an embodiment of the present disclosure, if a touch manipulation on the object 10 is inputted, the control module 130 may change the UI indicating the application execution region. For example, before a touch manipulation on the object 10 is inputted, a name of an application corresponding to each of the first region 20 and the second region 30 may be displayed under a control of the control module 130. After a touch manipulation on the object 10 is inputted, an execution screen of an application corresponding to each of the first region 20 and the second region 30 may be displayed under a control of the control module 130.

An electronic apparatus according to various embodiments of the present disclosure may include a display configured to display an object for an application execution, an input module configured to receive a touch manipulation on an object, and a control module configured to execute the first application if the touch manipulation ends in the first region of the display and execute the second application if the touch manipulation ends in the second region of the display. The control module may change an area of the first region and an area of the second region according to the number of executions and execution time of the first application and the second application.

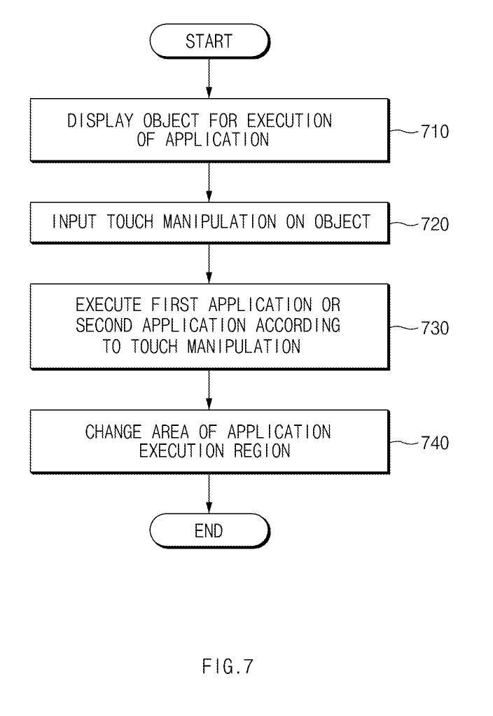

FIG. 7 is a flowchart illustrating an application execution method of an electronic apparatus according to various embodiments of the present disclosure. The flowchart illustrated in FIG. 7 may include operations processed in an electronic apparatus 100 illustrated in FIG. 1. Accordingly, even though not described below, a description on the electronic apparatus 100 given with respect to FIGS. 1 to 6B may be applied to the flowchart illustrated in FIG. 7.

Referring to FIG. 7, in operation 710, the electronic apparatus 100 may display an object for an application execution. According to an embodiment of the present disclosure, the electronic apparatus 100 may display an object for an application execution on a lock screen. The term lock screen may mean a screen which is used, for example, to receive a user manipulation, such as a password input, a touch, or the like, to enter a main screen.

In operation 720, the electronic apparatus 100 may receive a touch manipulation on an object. For example, the electronic apparatus 100 may receive a touch manipulation such as a swipe, a flick, or the like.

In operation 730, the electronic apparatus 100 may execute a first application or a second application according to the touch manipulation. For example, a control module 130 may execute the first application if a touch manipulation of a user ends in the first region of a display 110 and may execute the second application if a touch manipulation of a user ends in the second region of the display 110.

According to an embodiment of the present disclosure, the first region may be one of a plurality of regions that result by passing a straight line through an object, and the second region may be the other of the regions divided by the straight line passing through the object. According to an embodiment of the present disclosure, the first region or the second region may be at least a portion (e.g., part or all) of each of a plurality of regions that result by passing a straight line passing through an object.

According to an embodiment of the present disclosure, the first region may be an inner region of an arc of a circle of which the center is an object or an edge adjacent to the object, and the second region may be an outer region of the arc of the circle of which the center is the object or the edge adjacent to the object. According to an embodiment of the present disclosure, the second region may be at least a portion (e.g., a part or all) of an outer region of an arc of a circle of which the center is an object.

According to an embodiment of the present disclosure, the first application may be a front camera application, and the second application may be a rear camera application. According to an embodiment of the present disclosure, the first application and/or the second application may be changed by a user setting.

In operation 740, the electronic apparatus 100 may change an area of application execution region (e.g., the first region or the second region). For example, the electronic apparatus 100 may change an area of the first region and an area of the second region in proportion to the number of executions or the execution time of the first application and the second application. According to an embodiment of the present disclosure, the electronic apparatus 100 may change an area, which is initially set, of the first region and an area, which is initially set, of the second region according to the number of executions or the execution time of the first application and the second application. According to an embodiment of the present disclosure, the electronic apparatus 100 may change a ratio of an area of the first region to an area of the second region, with the whole region of the first region and the second region maintained.

According to an embodiment of the present disclosure, the electronic apparatus 100 may display a UI indicating an application execution region (e.g., the first region or the second region). For example, if a touch manipulation is inputted (e.g., if a touch manipulation starts to be inputted), the electronic apparatus 100 may display a UI indicating an application execution region. For example, the electronic apparatus 100 may display the first region and the second region with different hues, brightness, or saturations. As another example, the electronic apparatus 100 may perform control to display a name of an application corresponding to the first region and the second region with a text. As a further example, the electronic apparatus 100 may perform control to display an icon of an application corresponding to a first region and a second region. As a still another example, if the first application and the second application are a front camera application and a rear camera application respectively, the electronic apparatus 100 may perform control to display a person image in the first region and a background image in the second region, respectively. According to an embodiment of the present disclosure, if the first application and the second application are a front camera application and a rear camera application respectively, the electronic apparatus 100 may display an image photographed by the front camera and an image photographed by the rear camera in the first region and the second region, respectively.

An application execution method of an electronic apparatus according to various embodiments of the present disclosure may include displaying for execution of an application, receiving a touch manipulation on the object, executing the first application if the touch manipulation ends in the first region of a display and executing the second application if the touch manipulation ends in the second region of the display, and changing an area of the first region and an area of the second region according to the number of executions and execution time of the first application and the second application.

An application execution method of an electronic apparatus according to various embodiments of the present disclosure may be implemented with a program executable in an electronic apparatus. Moreover, the program may be stored in various recoding media.

For example, a program code for executing any of the aforementioned methods may be stored in a variety of nonvolatile recoding media such as flash memory, a read only memory (ROM), an erasable programmable ROM (EPROM), an electronically erasable and programmable ROM (EEPROM), a hard disk, a removable disk, a memory card, a universal serial bus (USB) memory, a compact disc-ROM (CD-ROM), and the like.

A computer-readable recording medium according to various embodiments of the present disclosure may store a program for executing a method, which includes displaying an object for execution of an application, receiving a touch manipulation on the object, executing a first application if the touch manipulation ends in the first region of a display and executing the second application if the touch manipulation ends in the second region of the display, and changing an area of the first region and an area of the second region according to the number of executions and execution time of the first application and the second application.

According to various embodiments of the present disclosure, an application may be conveniently executed on a lock screen, and a specific application may be conveniently and intuitively executed by providing a UI for execution of an application.

According to various embodiments of the present disclosure, a UI may be provided in consideration of a status of an application used by a user, thereby making it possible to maximize a user convenience.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic apparatus comprising:
a display configured to display an object for an application execution;
an input module configured to receive a touch manipulation on the object; and
a control module configured to:
execute a first application if the touch manipulation ends in a first region,
execute a second application if the touch manipulation ends in a second region, and
change an area of the first region and an area of the second region according to a number of executions or execution time of the first application and the second application.

2. The electronic apparatus of claim 1, wherein the area of the first region and the area of the second region are changed in proportion to the number of executions or the execution time of the first application and the second application.

3. The electronic apparatus of claim 1, wherein the first region is one of a plurality of regions that result by passing a straight line through the object, and
wherein the second region is the another of the plurality of regions.

4. The electronic apparatus of claim 1, wherein the first region includes an inner region of an arc of a circle of which the center is the object or an edge adjacent to the object, and
wherein the second region includes an outer region of the arc of the circle of which the center is the object or an edge adjacent to the object.

5. The electronic apparatus of claim 1, wherein the first application is a front camera application and the second application is a rear camera application.

6. The electronic apparatus of claim 1, wherein the control module is further configured to perform control to display a user interface indicating the first region or the second region.

7. The electronic apparatus of claim 6, wherein the control module is further configured to perform control to display the first region and the second region with different hues, brightness or saturations.

8. The electronic apparatus of claim 6, further comprising:
a front camera configured to photograph an image in front of the electronic apparatus; and
a rear camera configured to photograph an image in the rear of the electronic apparatus,
wherein the control module is further configured to perform control to display an image photographed by the front camera in the first region and to display an image photographed by the rear camera in the second region.

9. The electronic apparatus of claim 6, wherein the control module is further configured to perform control to:
display a person image in the first region, and
display a background image in the second region.

10. An application executing method of an electronic apparatus, the application executing method comprising:
displaying an object for an application execution;
receiving a touch manipulation on the object;
executing a first application if the touch manipulation on the object ends in a first region and executing a second application if the touch manipulation ends in a second region; and
changing an area of the first region and an area of the second region according to the number of executions or execution time of the first application and the second application.

11. The application executing method of claim 10, wherein the changing of the area comprises:
changing the area of the first region and the area of the second region in proportion to the number of executions or the execution time of the first application and the second application.

12. The application executing method of claim 10, wherein the first region is one of a plurality of regions that result by passing a straight line through the object, and
wherein the second region is another of the plurality of regions.

13. The application executing method of claim 10, wherein the first region includes an inner region of an arc of a circle of which the center is the object or an edge adjacent to the object, and
wherein the second region includes an outer region of the arc of the circle of which the center is the object or an edge adjacent to the object.

14. The application executing method of claim 10, wherein the first application is a front camera application and the second application is a rear camera application.

15. The application executing method of claim 10, further comprising:
displaying a user interface indicating the first region or the second region if the touch manipulation is inputted.

16. The application executing method of claim 15, wherein the displaying of the user interface comprises:
displaying the first region and the second region with different hues, brightness, or saturations.

17. The application executing method of claim 15, wherein the displaying of the user interface comprises:
displaying an image photographed by a front camera in the first region and an image photographed by a rear camera in the second region, respectively.

18. The application executing method of claim 15, wherein the displaying of the user interface comprises:
performing control to display a person image in the first region and to display a background image in the second region.

19. A computer-readable recording medium recorded with a program which performs a method, the method comprising:
displaying an object for an application execution;
receiving a touch manipulation on the object;
executing a first application if the touch manipulation on the object ends in a first region and executing a second application if the touch manipulation ends in a second region; and
changing an area of the first region and an area of the second region according to the number of executions or execution time of the first application and the second application.
